(19) United States
(12) Patent Application Publication
(10) Pub. No.: US 2010/0136163 A1
(43) Pub. Date: Jun. 3, 2010

(54) METHOD OF WEIGHT CONTROL EMPLOYING CHEWING GUM

(75) Inventors: Gilbert A. Leveille, Denville, NJ (US); Kathleen E. McMahon, Evanston, IL (US); Steven E. Zibell, Tinley Park, IL (US); David Record, River Forest, IL (US)

Correspondence Address: K&L Gates LLP, P.O. Box 1135, CHICAGO, IL, 60690, US

(73) Assignee: WM. WRIGLEY JR. COMPANY, Chicago, IL (US)

(21) Appl. No.: 12/445,422

(22) PCT Filed: Oct. 12, 2007
(86) PCT No.: PCT/US07/81196

§ 371 Date: Jan. 20, 2010

Related U.S. Application Data
(60) Provisional application No. 60/829,464, filed on Oct. 13, 2006.

(51) Int. Cl. A23G 4/00

(52) U.S. Cl. 426/3

(57) ABSTRACT

The present invention is directed to methods for managing body weight by substituting a chewing gum composition on a regular basis for a snack product having a greater caloric content than the chewing gum composition or by employing a chewing gum composition in conjunction with behavior modification. Additionally, the present invention includes a method of controlling behavior modification relating to weight loss including identifying the behavior to be modified, setting behavioral goals relating to weight management, modifying determinants of the behavior to be changed using, in part, a chewing gum composition, and reinforcing the desired behavior using, in part, a chewing gum composition.

### BACKGROUND

The present invention relates generally to methods of controlling body weight. More particularly, the present invention provides for weight management by controlling caloric intake.

Today, nearly two-thirds of adults in the United States are overweight, and one-half of those individuals are considered obese. Moreover, obesity and related illnesses can effectively reduce the life expectancy of adults by four to nine months. Consequently, many Americans are searching for ways to better manage their weight.

Currently, treatments for conditions such as obesity and overeating include psychological interventions, dietetics, exercise, gastric balloons, stomach stapling, jaw wiring, surgery, drugs and behavior modification. Additionally, it is well known that an effective method of controlling weight requires a daily balance of caloric intake and energy expended. When the amount of calories consumed in one day is greater than the amount of energy expended, an increase in weight occurs. Conversely, research has shown that a calorie savings each day can impact total caloric intake over time, thereby preventing weight gain. Therefore, there exists a need for methods of controlling caloric intake to manage body weight.

### SUMMARY

The present invention generally provides methods and programs for managing body weight utilizing a chewing gum composition. To this end, the methods and programs may be used, for example, to prevent unwanted weight gain, assist in weight loss, induce weight gain or maintain current weight.

Pursuant to the present invention, a method of weight management is provided where an individual is instructed to substitute on a regular basis a chewing gum composition for a snack product having more calories than the chewing gum composition.

In an embodiment, the snack product comprises more than 100 calories.

In an embodiment, the individual substitutes the chewing gum composition daily for a period of time, for example, for at least two weeks.

In another embodiment, the individual substitutes the chewing gum at least twice daily.

The individual could continue to substitute the chewing gum composition until the individual loses a desired amount of weight.

In another embodiment of the present invention, a method is provided for controlling weight management through behavior modification. The method comprises providing a program designed to modify the eating habits of an individual. The program comprises instructing an individual to substitute, on a daily basis for at least a set period of time, a chewing gum composition for a snack product having more calories than the chewing gum composition. The program further comprises using the chewing gum composition as a behavior modification tool to modify the eating habits of the individual.

In an embodiment, the behavior modification tool is used in conjunction with another behavior modification.

In an embodiment, the behavior modification tool is used with cognitive-behavioral therapy.

In an embodiment, the chewing gum composition is used to improve compliance with the modification of the eating habits of the individual.

Pursuant to the program, the individual can be instructed to chew the gum composition while shopping for food.

Likewise, the individual can be instructed to chew the gum after a stressful event.

In yet another embodiment of the present invention, a method is provided for controlling behavior modification relating to weight management. The method comprises identifying weight management behaviors to be modified; setting specific behavioral goals relating to weight management; modifying determinants of the behavior to be changed using, in part, a chewing gum composition; and reinforcing the desired behavior using, in part, a chewing gum composition.

A variety of behaviors can be modified. For example, in an embodiment, a specific behavioral goal is to modify eating habits.

In addition, a specific behavioral goal can be to modify physical activity habits.

Likewise, the desired behavior is reinforced using cognitive-behavioral therapy.

In a still further embodiment of the present invention, a weight loss program is provided for an individual. The program comprises using a chewing gum composition on a regular basis as a substitute for food products having at least twenty times the caloric content of the chewing gum composition.

In an embodiment, the individual substitutes the chewing gum composition until the individual loses a desired amount of weight.

An advantage of the present invention is to provide improved weight management systems.

A further advantage of the present invention is to provide an improved weight management system using behavior modification.

Another advantage of the present invention is to provide an improved method of controlling behavior modification with relation to weight management.

Moreover, an advantage of the present invention is to provide improved weight loss programs.

Still yet another advantage of the present invention is to provide chewing gum to manage body weight.

Additional features and advantages are described herein, and will be apparent from, the following Detailed Description.

### DETAILED DESCRIPTION

The present invention generally provides methods of weight management for controlling the body weight of human beings. Control of body weight may involve weight reduction, weight gain, or current weight maintenance. The methods of the present invention may be used for treating any condition in which regulating food intake is beneficial. These conditions include, for example, overeating, overweight, obesity and disorders caused or exacerbated thereby.

Moreover, health and longevity can be seriously affected by obesity or eating disorders, including anorexia, bulimia and overweight. For example, excessive weight is associated with elevated serum cholesterol, elevated blood pressure, and non-insulin-dependent diabetes mellitus. Excessive weight also increases the risk for gallbladder disease, gout, coronary heart disease, some types of cancer and has also been implicated in the development of osteoarthritis of the weight-bearing joints.

The underlying cause of excessive weight gain is unknown. However, the basic mechanism is known to be an imbalance between caloric intake and energy expenditure. The reason that this imbalance occurs remains unclear. Evidence suggests that the cause of weight gain is multifactorial in origin, reflecting inherited, environmental, cultural, socioeconomic, and psychological conditions. Increasing physiologic, biochemical, and genetic evidence suggests that being overweight is not simply a problem of will power, as is sometimes implied, but is a complex disorder of appetite regulation and energy metabolism.

Currently, treatments for obesity and overeating include psychological interventions, dietetics, exercise, gastric balloons, stomach stapling, jaw wiring, surgery, drugs and behavior modifications. Generally speaking, however, an overall goal in treating obesity and overeating is to reduce caloric intake to a level below the amount of energy expended to result in weight loss.

An aspect of the present invention is to provide methods of weight management that reduce caloric intake by substituting a chewing gum composition for a snack product having a greater caloric content than the chewing gum composition. For example, substitution of two servings of chewing gum at approximately 20 calories for a handful of chocolate chip cookies that contains 140 calories constitutes a 120 calorie saving. Therefore, by potentially reducing caloric intake, this method of weight management can be extremely beneficial to individuals who seek to control their body weight.

Preferably, the substitution of the chewing gum composition for a snack product having a greater caloric content than the chewing gum composition occurs on a regular basis. For example, the substitution of the chewing gum composition occurs daily, at least twice daily, on a daily basis for at least two weeks, or until the individual loses a desired amount of weight. Of course, a variety of programs having a variety of lengths can be designed. Likewise, the chewing gum can be substituted for any food product any number of times daily.

As noted above, any food product can be substituted for by the chewing gum composition. Typically, the snack products will comprise a caloric content greater than 100 calories. Thus, by substituting chewing gum for a snack product, at least a ten fold calorie saving is achieved. Of course, greater calorie savings can be realized by substituting the chewing gum for food products or snacks having even a greater calorie content.

In an embodiment of the present invention a method of controlling behavior modification relating to weight management is provided, which comprises: (1) identifying eating or related life-style behaviors to be modified; (2) setting specific behavioral goals; (3) modifying determinants of the behavior to be changed using, in part, a chewing gum composition; and (4) reinforcing the desired behavior using, in part, a chewing gum composition. The specific behavioral goals to be treated can be related to modification of eating and physical activity habits, and typically focus on gradual changes. Moreover, behavior modification can be undertaken alone or in conjunction with other approaches.

Additional examples of behavior modification relating to weight management can include, but are not limited to, the following activities: self-monitoring such as keeping daily records of food intake, physical activities, and checking weight regularly; problem solving as a method of analyzing and identifying possible solutions; contingency management to help recover from overeating or weight regain; stimulus control to aid in avoiding trigger that prompt eating; stress management to decrease the negative impact of stress on positive behavior patterns; social support from family members and friends to modify lifestyle behaviors; and cognitive restructuring to teach people to think in a positive manner and to correct thoughts that undermine weight management efforts. Cognitive techniques can also be used to help people to accept realistic, but less-than-desired, weight losses so as to avoid inappropriate feelings of failure after achieving a modest, but clinically-important weight loss that can lead to relapse and weight regain.

Generally, there are two specific components of behavior change: self-monitoring and cognitive skills. Cognitive Behavioral Therapy (CBT) is a cognitive therapy in that this method focuses on changing the cognitive (thought) processes that in turn, affect behavioral changes. Cognitive-Behavioral Therapy (CBT) sessions (individual and group) may reinforce the behavior modification disclosed herein through application of knowledge gained through basic and applied scientific research in psychology and related fields (e.g., learning, memory, emotions, physiology) to problems individuals face on a daily basis.

Cognitive techniques may be employed where a person is unable to control their eating habits. For example, when food is readily available to an individual, that individual may ingest the food whether they are hungry or not. This reaction may occur in instances where the individual suffers from impulsive snacking, boredom or increased levels of stress, for example. In these cases, cognitive functioning is overcome by an impulsive behavior toward food, which often leads to overeating. To avoid development of such impulsive eating habits, experts advise that an individual use cognitive techniques before eating in order to make sound choices and avoid excessive eating.

In an embodiment, cognitive-behavioral therapy can also be used with the method of controlling behavior modifications relating to weight management as a source of reinforcement for the desired behavior modification.

Behavior modification can help induce weight loss, maintain current weight and is an appropriate treatment not only for adults, but for children and adolescents as well. It may be difficult, however, for people to participate in group behavior modification therapy because of a lack of local expertise, schedule conflicts, and expense. An aspect of the present invention is to provide a safe, effective, available and affordable method of incorporating behavior modification with weight management that does not necessarily require a group.

Pursuant to the present invention, chewing gum is incorporated as part of a toolbox approach to behavior modification for weight management in a variety of different ways. For example, as discussed above, in certain situations individuals may be unable to control their desire for food and, therefore, become susceptible to impulse eating. Chewing gum can be used to fight impulse snacking brought on by exposure to stressful situations, boredom or even simply habit. For instance, an individual could chew a chewing gum composition before, during or after a stressful event for appetite suppression, or whenever an individual suffers from boredom in order to reduce the desire for a high-calorie snack.

In further embodiments, chewing a chewing gum composition can curb excessive food intake caused by impulse eating, reduce the desire for a high-calorie snack, reduce the total number of snacking occurrences and replace regular snacking occurrences when chewed twice daily. Therefore, chewing a chewing gum composition may be useful in combination with behavioral modifications to eliminate impulse eating and can serve as a portable, affordable and accessible diversion from high calorie snacks.

Additionally, weight gain caused by excessive caloric intake is a common result of ingesting unnecessarily large portions of food during a meal. Chewing gum can be used a way to reduce the amount of calories consumed before or during the meal. For example, chewing a chewing gum composition prior to consumption, concurrent with food consumption, or with combinations thereof, can serve as a replacement for food consumption, thereby preventing weight gain.

In additional embodiments, chewing a chewing gum composition can be used after a meal to signal the end of a meal, to administer satiety or to induce satiety caused by behavioral, cognitive, or physiological factors, alone or in combination.

Focusing on an individual's behavior toward food can also be a successful way to reduce food intake. Certain situations can lead to overeating when a behavior in a situation is induced by physical stimuli that trigger one's senses. For example, while shopping in a supermarket, an individual may smell an aroma of a favorite food or see a palatable food on a table, which may induce a feeling of hunger or the need to buy a greater quantity of food. By controlling the types and volume of food an individual buys from a supermarket, there is a greater chance one can control their food intake. An aspect of the present invention is to provide methods of weight management where an individual chews a chewing gum composition while shopping in a supermarket to reduce feelings of hunger, thereby reducing the volume of food purchased, and consequently reducing the amount of food intake.

In a further embodiment, a chewing gum composition may be chewed while shopping in a supermarket to influence the purchase of healthier foods.

Another aspect of the present invention provides methods of weight management that include administration of a chewing gum composition for behavioral modification in conjunction with other behavior modification activities. These additional behavior modification activities include, but are not limited to, exercise, nutritional education, meditation, hypnosis, affirmation, attending support groups, calorie counting, participating in computer-based programs, medications, identifying high-risk activities (such as eating favorite high-calorie foods), and changing unrealistic beliefs about body image and the like, alone or in combination.

Additionally, weight gain associated with cessation of smoking is sometimes attributed to the fact that nicotine increases heart rate and metabolism such that readjustment to a lower metabolic rate is required once nicotine is no longer present in the bloodstream. However, resulting weight gain may also be attributed either to the fact that nicotine is an appetite suppressant, or to the need for emotional comfort in a person suffering from unpleasant symptoms associated with nicotine withdrawal. Instead of ingesting food to aid in smoking cessation, substitution of a chewing gum composition will reduce caloric intake, thereby reducing weight gain associated with smoking cessation. Therefore, in an embodiment, a method of weight management includes chewing a chewing gum composition to reduce or prevent weight gain associated with smoking cessation.

In another embodiment, the method of weight management includes chewing a chewing gum composition after smoking to reduce the desire to smoke additional cigarettes.

Yet still another aspect of the present invention is to provide weight loss programs where a chewing gum composition is used on a regular basis as a substitute for food products having at least twenty times the caloric content of the chewing gum composition. In an embodiment, the weight loss program is used until the individual loses a desired amount of weight.

Additional conditions that are treatable by the methods of the present invention include, for example, conditions that are associated with a psychological factor, such as binge eating disorder, night eating syndrome, obsessive eating, compulsive eating and bulimia.

By effectively regulating food intake in human subjects and improving compliance with the modification of an individual's eating habits, the calorie restriction methods described hereinabove may further be used for inducing or maintaining weight loss, for preventing weight gain after or during a weight reducing diet, or for preventing weight gain in a subject having a condition associated with weight gain.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method of weight management comprising the steps of:
instructing an individual to substitute on a daily basis for a period of time a chewing gum composition for a snack product having a greater caloric content than the chewing gum composition.

2. The method of claim 1 wherein the snack product comprises a caloric content greater than 100 calories.

3. The method of claim 1 wherein the individual substitutes the chewing gum composition at least twice daily.

4. The method of claim 1 wherein the individual substitutes the chewing gum composition on a daily basis for at least two weeks.

5. The method of claim 1 wherein the individual substitutes the chewing gum composition until the individual loses a desired amount of weight.

6. A method of controlling weight management through behavior modification comprising the steps of:
providing a program designed to modify the eating habits of an individual, the program comprising:
instructing the individual to substitute, on a daily basis for at least a set period of time, a chewing gum composition for a snack product having a greater caloric content than the chewing gum composition; and
using the chewing gum composition as a behavior modification tool to modify the eating habits of the individual.

7. The method of claim 6 wherein the snack product comprises a caloric content greater than 100 calories.

8. The method of claim 6 wherein the individual substitutes the chewing gum composition at least twice daily.

9. The method of claim 6 wherein the individual substitutes the chewing gum composition for at least two weeks.

10. The method of claim 6 wherein the individual substitutes the chewing gum composition until the individual loses a desired amount of weight.

11. The method of claim 6 wherein the behavior modification tool is used in conjunction with another behavior modification.

12. The method of claim 6 wherein the behavior modification tool is used with cognitive-behavioral therapy.

13. The method of claim 6 wherein the chewing gum composition is used to improve compliance with the modification of the eating habits of the individual.

14. The method of claim 6 comprising the step of instructing the individual to chew the gum composition while shopping for food.

15. The method of claim 6 comprising the step of instructing the individual to chew the gum composition after a stressful event.

16. A method of controlling behavior modification relating to weight management comprising the steps of:
identifying weight management behaviors to be modified;
setting specific behavioral goals relating to weight management;
modifying determinants of the behavior to be changed utilizing, in part, a chewing gum composition; and
reinforcing the desired behavior utilizing, in part, the chewing gum composition.

17. The method of claim 16 wherein a specific behavioral goal is to modify eating habits.

18. The method of claim 16 wherein a specific behavioral goal is to modify physical activity habits.

19. The method of claim 16 wherein the desired behavior is reinforced using cognitive-behavioral therapy.

20-21. (canceled)
